(19) United States
(12) Patent Application Publication
(10) Pub. No.: US 2008/0103943 A1
(43) Pub. Date: May 1, 2008

(54) METHOD OF SELLING A VEHICLE

(76) Inventors: Jim L. Williams, Lexington, KY (US); Brian J. Williams, Lexington, KY (US)

Correspondence Address: KING & SCHICKLI, PLLC, 247 NORTH BROADWAY, LEXINGTON, KY, 40507, US

(21) Appl. No.: 11/875,214

(22) Filed: Oct. 19, 2007

Related U.S. Application Data
(60) Provisional application No. 60/855,356, filed on Oct. 30, 2006.

(51) Int. Cl. G06Q 10/00

(52) U.S. Cl. 705/28

(57) ABSTRACT

A method of selling a vehicle to a purchaser includes the steps of providing a vehicle sales network including a primary dealer and at least one secondary dealer, the secondary dealer maintaining a vehicle inventory, the primary dealer offering a vehicle from the vehicle inventory for sale to a purchaser, the primary dealer accepting an offer from the purchaser to purchase the vehicle and the primary dealer purchasing the vehicle from the secondary dealer and then selling the vehicle to the purchaser.

This application claims the benefit of U.S. Provisional Patent Application Ser. No. 60/855,356 filed on 30 Oct. 2006.

### TECHNICAL FIELD OF THE INVENTION

The present invention relates generally to a method of selling a vehicle through a vehicle sales network including a primary dealer and at least one secondary dealer.

### BACKGROUND OF THE INVENTION

Automotive dealers around the country maintain limited inventories of used vehicles for sale to purchasers. Some of these vehicles are purchased at auction or from used vehicle wholesalers while others are acquired as trade-ins on other new or used vehicles sold by the dealers. Typically, the used car inventories are limited and the dealers themselves typically market over a limited geographic area and, therefore, have limited access to potential purchasers. This often makes it difficult to match purchaser desires with available inventory in order to complete sales transactions. The present invention relates to a method of selling vehicles wherein a vehicle sales network enhances the ability of the dealers to sell used vehicles and purchasers to find the vehicles they desire.

### SUMMARY OF THE INVENTION

In accordance with the purposes of the present invention as described herein, a method is provided for selling a vehicle to a purchaser. The method comprises the steps of: (1) providing a vehicle sales network including a primary dealer and at least one secondary dealer; (2) the secondary dealer maintaining a vehicle inventory; (3) the primary dealer offering a vehicle from the vehicle inventory for sale to a purchaser; (4) the primary dealer accepting an offer to purchase the vehicle from the purchaser; and (5) the primary dealer purchasing the vehicle from the secondary dealer and then selling the vehicle to the purchaser. The method may further include the offering of the vehicle inventory for sale over the internet. Still further the method includes licensing the primary dealer to do business in multiple states.

In accordance with additional aspects of the present invention, the method includes providing a nationwide network of secondary dealers. Further, the primary dealer may have business locations in multiple states. In accordance with one possible embodiment of the invention, the primary dealer operates without maintaining its own vehicle inventory. Further the method may include limiting purchaser contact to the primary dealer. Financing for the purchase of the vehicle may be provided through the primary dealer. Further, warranty sales for the vehicle may also be provided through the primary dealer. Vehicle service may also be provided by the primary dealer.

In the following description there is shown and described several preferred embodiments of this invention, simply by way of illustration of some of the modes best suited to carry out the invention. As it will be realized, the invention is capable of other different embodiments and several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of the specification, illustrates several aspects of the present invention and together with the description serves to explain certain principals of the invention. In the drawing:

FIG. 1 is a schematical block diagram of the business method of the present invention.

Reference will now be made in detail to the present preferred embodiment of the invention, an example of which is illustrated in the accompanying drawing.

### DETAILED DESCRIPTION OF THE INVENTION

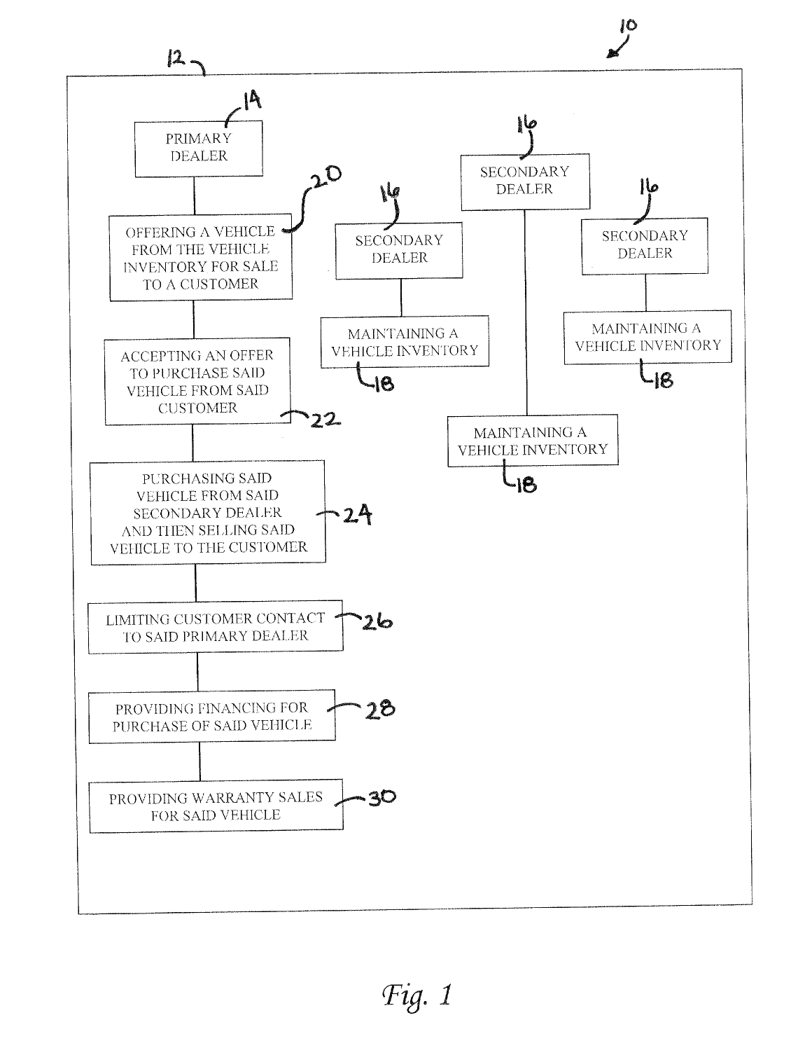

Reference is now made to FIG. 1 which broadly illustrates the method 10 of the present invention of selling a vehicle to a purchaser. The method includes providing a vehicle sales network 12 including a primary dealer 14 and at least one secondary dealer 16. Each of the secondary dealers 16 maintains a vehicle inventory 18. Preferably multiple secondary dealers 16 are included in the network in order to provide a larger inventory selection for potential purchasers. The primary dealer 14 offers a vehicle from the vehicle inventory 18 for sale to a purchaser (see step 20). In addition the primary dealer 14 accepts an offer to purchase the vehicle from the purchaser (see step 22). Upon accepting that offer, the primary dealer 14 purchases the vehicle from the secondary dealer 16 that has that vehicle in inventory and then the primary dealer sells that vehicle to the purchaser (see step 24). In accordance with one embodiment of the present invention this is done while the primary dealer 14 limits the purchaser contact to the primary dealer (see step 26) thereby making the secondary dealer 16 invisible to the purchaser.

In accordance with additional aspects of the present invention, the method includes the step 28 of providing financing for the purchase of the vehicle through the primary dealer where the purchaser desires such financing. Still further, the method may include the step 30 of providing warranty sales for the vehicle through the primary dealer 14 where the purchaser is interested in a warranty. In addition, the primary dealer may also offer and provide to the purchaser a vehicle inspection and/or vehicle service.

In accordance with additional aspects, the primary dealer 14 may offer a vehicle from the vehicle inventory 18 for sale to a purchaser over the internet in order to reach more potential purchasers and take advantage of the recent popularity for making purchases on-line. In addition, the method may include licensing the primary dealer 14 to do business in multiple states so as to make the business visible and reachable by more potential purchasers. Still further, the method may include providing a nationwide network of secondary dealers 16 so as to increase available inventor for the potential purchasers and aid more secondary dealers in moving used car inventories. Still further, in accordance with one possible aspect and embodiment of the present invention the primary dealer 14 may operate without maintaining a vehicle inventory, thereby only selling vehicles from the vehicle inventory of the secondary dealers. Thus, the primary dealer 14 doesn't have capital tied up in a depreciating inventory.

In accordance with the present method, the primary dealer 14 keeps the sellers (ie the secondary dealers 16 and the purchasers) apart from one another and acts as an intermediary throughout the entire transaction. Each purchaser and seller deals with the primary dealer and not an unknown entity.

Once a vehicle is sold, the primary dealer 14 gives a draft for full payment to the secondary dealer 16, payable upon delivery of a clean title. The purchaser then submits payment for the vehicle to the primary dealer 14. The primary dealer 14 handles the transfer of documents, saving the purchaser and seller time and worry.

During the transaction, the primary dealer 14 offers additional services and assurances for a fee. The primary dealer 14 offers inspections on the purchased vehicle. A limited money back guarantee may be given to the purchaser who uses the inspection service. This offers the purchaser peace of mind.

The primary dealer 14 may also offer financing options and warranty options, giving the purchaser still more comfort and peace of mind. This is particularly beneficial when one remembers that the purchase is often being made sight unseen over the internet. The primary dealer 14 can also arrange to have the vehicle delivered to the purchaser or made available for pick up at a local office. The primary dealer 14 could also offer vehicle service if desired.

By this method, the primary dealer 14 is able to overcome many hurdles that prevent people from buying or selling vehicles online.

The foregoing description of several preferred embodiments of the invention has been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the appended claims when interpreted in accordance with the breadth to which they are fairly, legally and equitably entitled.

What is claimed:

1. A method of selling a vehicle to a purchaser, comprising:
providing a vehicle sales network including a primary dealer and at least one secondary dealer;
said at least one secondary dealer maintaining a vehicle inventory;
said primary dealer offering a vehicle from said vehicle inventory for sale to a purchaser;
said primary dealer accepting an offer to purchase said vehicle from said purchaser; and
said primary dealer purchasing said vehicle from said at least one secondary dealer and then selling said vehicle to said purchaser.

2. The method of claim 1, including offering said vehicle inventory for sale over the internet.

3. The method of claim 2, including licensing said primary dealer to do business in multiple states.

4. The method of claim 3, including providing a nationwide network of secondary dealers.

5. The method of claim 4, including providing business locations in multiple states for said primary dealer.

6. The method of claim 5, including operating said primary dealer without said primary dealer maintaining a vehicle inventory.

7. The method of claim 6, wherein said vehicle inventory is used vehicles.

8. The method of claim 7, including limiting purchaser contact to said primary dealer.

9. The method of claim 1, including limiting purchaser contact to said primary dealer.

10. The method of claim 1, including providing financing for purchase of said vehicle through said primary dealer.

11. The method of claim 1, including providing warranty sales for said vehicle through said primary dealer.

12. The method of claim 1, including said primary dealer providing delivery of said vehicle to said purchaser.

13. The method of claim 1, including said primary dealer providing an inspection of said vehicle for said purchaser.

14. The method of claim 1, including said primary dealer providing service of said vehicle for said purchaser.
